(19) United States
(12) Patent Application Publication
(10) Pub. No.: US 2017/0352057 A1
(43) Pub. Date: Dec. 7, 2017

(54) TARGETED MARKETING BASED ON A USER INTEREST AND LOCATION

(71) Applicant: International Business Machines Corporation, Armonk, NY (US)

(72) Inventors: Dhruv A. Bhatt, Indian Trail, NC (US); Bhargav Cheenepalli, Charlotte, NC (US); Kristin E. McNeil, Charlotte, NC (US); Nitaben A. Patel, Charlotte, NC (US)

(21) Appl. No.: 15/172,948

(22) Filed: Jun. 3, 2016

(51) Int. Cl. G06Q 30/02; H04L 29/08

(52) U.S. Cl. CPC G06Q 30/0261; G06Q 30/0256; H04L 67/18

(57) ABSTRACT

In an approach to determining targeted marketing for a user, a computer determines a user interest in at least one product, and determines a location of the user. The computer then determines at least one merchant within a first distance of the user, and whether the at least one merchant has the at least one product available. Responsive to determining the at least one merchant has the at least one product, the computer then generates an alert to the user indicating the at least one product availability.

### BACKGROUND

The present invention relates generally to the field of mobile computing applications, and more particularly to determining targeted marketing based on at least a user interest in a product or service and a user location.

With an ever increasing number of merchants competing for a consumer's business in today's retail market, it becomes more important for an individual merchant to differentiate itself from others. Many merchants are developing marketing campaigns aimed at increasing sales within a physical store, as opposed to online sales, however, many of these campaigns are targeted generally at consumers, and not personalized for each consumer.

### SUMMARY

Embodiments of the present invention disclose a method, a computer program product, and a computer system for determining targeted marketing for a user. The method may include one or more computer processors determining a user interest in at least one product, and determining a location of the user. The one or more computer processors then determine at least one merchant within a first distance of the user, and whether the at least one merchant has the at least one product available. In response to determining the at least one merchant has the at least one product, the one or more computer processors generate an alert to the user indicating the at least one product availability.

### BRIEF DESCRIPTION OF THE DRAWINGS

FIG. 1 is a functional block diagram illustrating a data processing environment, in accordance with an embodiment of the present invention;

FIG. 2 is a flowchart depicting operational steps of a targeting program, for determining targeted marketing to a user based at least on a user interest in a product or service and a user location, in accordance with an embodiment of the present invention;

FIG. 3 is a block diagram of components of a data processing system, such as the server computing device of FIG. 1, in accordance with an embodiment of the present invention;

FIG. 4 depicts a cloud computing environment, in accordance with an embodiment of the present invention; and

FIG. 5 depicts abstraction model layers, in accordance with an embodiment of the present invention.

### DETAILED DESCRIPTION

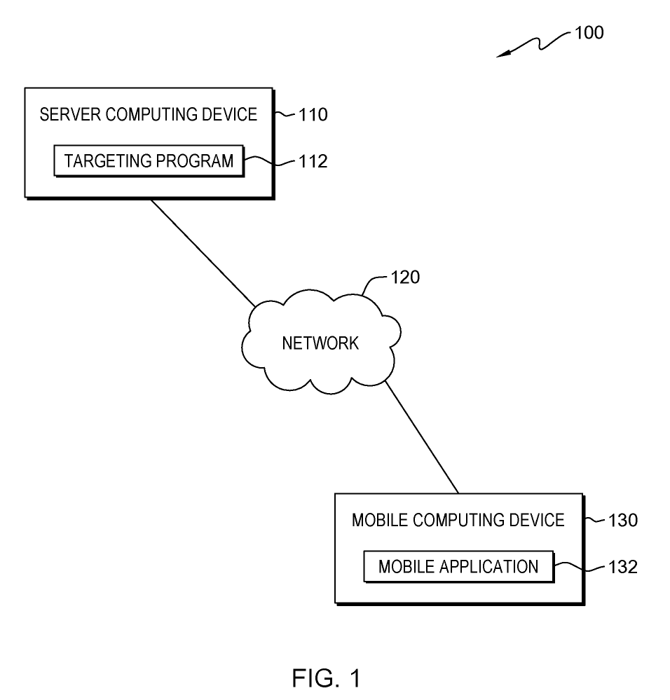

The present invention will now be described in detail with reference to the Figures. FIG. 1 is a functional block diagram illustrating a data processing environment, generally designated 100, in accordance with one embodiment of the present invention. In an embodiment, data processing environment 100 may be a distributed data processing environment. The term “distributed” can describe a computer system that includes multiple, physically distinct devices that operate together as a single computer system. FIG. 1 provides only an illustration of one implementation and does not imply any limitations with regard to the environments in which different embodiments may be made by those skilled in the art without departing from the scope of the invention as recited by the claims.

Data processing environment 100 includes server computing device 110 and mobile computing device 130, interconnected via network 120. Network 120 can be, for example, a telecommunications network, a local area network (LAN), a wide area network (WAN), such as the Internet, or a combination of the three, and can include wired, wireless, or fiber optic connections. Network 120 can include one or more wired and/or wireless networks that are capable of receiving and transmitting data, voice, and/or video signals, including multimedia signals that include voice, data, and video information. In general, network 120 can be any combination of connections and protocols that will support communications between server computing device 110, mobile computing device 130, and other computing devices (not shown) within data processing environment 100.

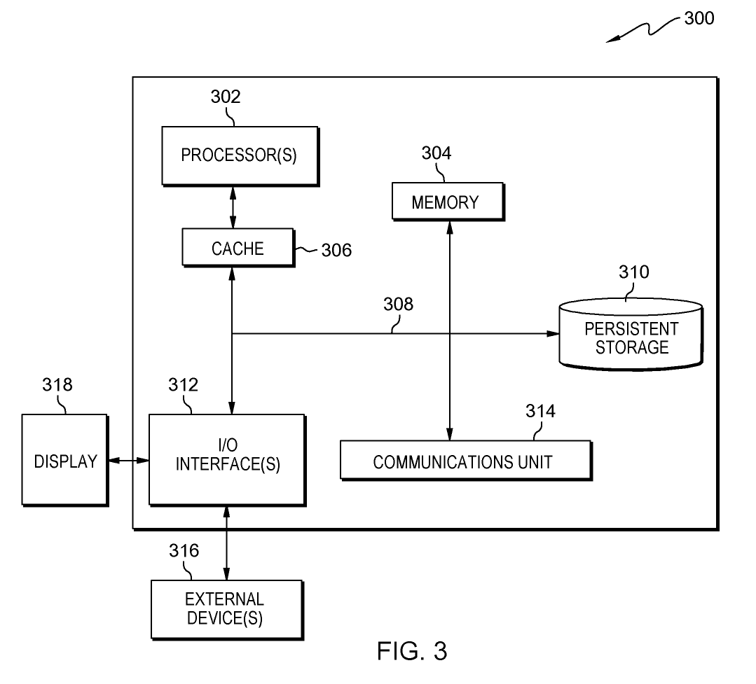

Server computing device 110 can be a standalone computing device, a management server, a web server, a mobile computing device, or any other electronic device or computing system capable of receiving, sending, and processing data. In other embodiments, server computing device 110 can represent a server computing system utilizing multiple computers as a server system, such as in a cloud computing environment. In another embodiment, server computing device 110 can be a laptop computer, a tablet computer, a netbook computer, a personal computer (PC), a desktop computer, a personal digital assistant (PDA), a smart phone, or any programmable electronic device capable of communicating with mobile computing device 130 and other computing devices (not shown) within data processing environment 100 via network 120. In another embodiment, server computing device 110 represents a computing system utilizing clustered computers and components (e.g., database server computers, application server computers, etc.) that act as a single pool of seamless resources when accessed within data processing environment 100. Server computing device 110 includes targeting program 112. Server computing device 110 may include internal and external hardware components, as depicted and described in further detail with respect to FIG. 3.

Targeting program 112 determines targeted marketing to a user based at least on the user's location and the user's interest in a product or service. Targeting program 112 retrieves one or more of a search history of the user, a list created by the user, or other online activity of the user in order to determine one or more products or services the user may be interested in purchasing. For purposes of the discussion herein, a product and a service can be used interchangeably and one or more products or services can include items, goods, or other offerings provided by a merchant, a retailer, a business, or other company or organization. Targeting program 112 determines a location of the user, and determines at least one merchant near the user. Targeting program 112 determines whether the at least one merchant has the product or service available, and if so, generates an alert to the user indicating availability of the product or service.

In various embodiments of the present invention, mobile computing device 130 can be one of a laptop computer, a tablet computer, a smart phone, or any programmable electronic device capable of communicating with various components and devices within data processing environment 100, via network 120. In general, mobile computing device 130 represents any programmable electronic device or combination of programmable electronic devices capable of executing machine readable program instructions and communicating with other computing devices (not shown) within data processing environment 100 via a network, such as network 120. In an embodiment, mobile computing device 130 includes Global Positioning System (GPS) functionality. Mobile computing device 130 includes at least one instance of mobile application 132.

Mobile application 132 is a mobile application software program, or a “mobile app” or an “app”, designed to run on a smart phone, a tablet computer, or other mobile devices. Mobile application 132 may be any native application, or pre-installed software, on a mobile computing device, such as mobile computing device 130. A native application can be, for example, a web browser, email client, mapping program, or an app for purchasing music, other media, or additional apps. Mobile application 132 may be a software application or a web application that can run in a mobile web browser. Mobile application 132 may be any app purchased by the user of mobile computing device 130, for example, a shopping app, a merchant-provided app, a coupon app, an app providing for the purchase of products or services, or an app including capabilities to allow a user to input product or service reviews.

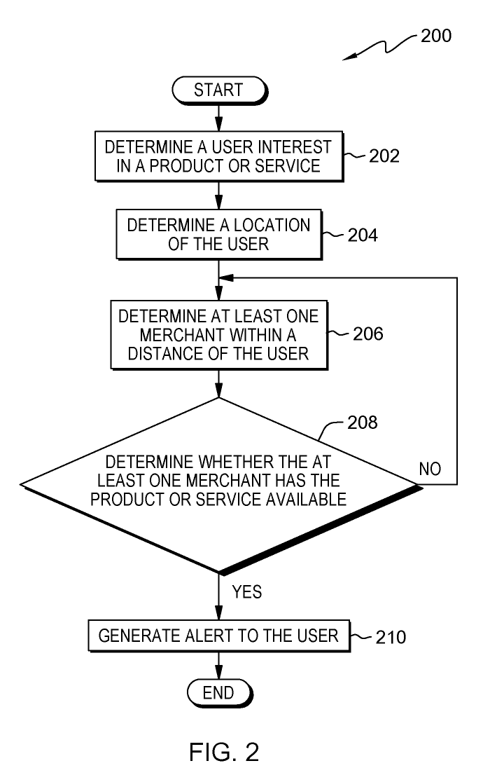

FIG. 2 is a flowchart 200 depicting operational steps of targeting program 112 for determining targeted marketing for a user based on at least a user interest in a product and a user location, in accordance with an embodiment of the present invention.

Targeting program 112 determines a user interest in a product or service (202). In an embodiment, targeting program 112 retrieves a user's search history, including search query terms and phrases, in order to determine potential products or services for the user. The search history may be retrieved from, for example, a search engine, a retail or other merchant online site, a browsing history of the user, or temporary cookies on the user device. In another embodiment, targeting program 112 retrieves a list created by the user, for example, on a mobile app or device native application, such as mobile application 132. The list may contain items to be purchased, or items the user may be interested in purchasing at some time in the future. In yet another embodiment, targeting program 112 retrieves a wish list, or items in the user's shopping cart on one or more merchant-provided mobile apps. In still another embodiment, targeting program 112 retrieves reviews or critiques the user has provided on one or more mobile apps in order to determine the user's interest or disinterest in a particular product or service. For example, a user may review a nail salon and include comments regarding a particular skin care product to which the user is allergic, and for which there is a known alternative product. In another embodiment, targeting program 112 retrieves information from one or more social networking applications associated with the user to determine possible future purchases, based, for example, on the user commenting on a post, or otherwise indicating a like or an interest in the post. Additional information may be retrieved from the one or more social networking applications, including, for example, a status update indicating a future vacation or an event. Targeting program 112 may retrieve a user's web history generally in order to determine product details, product comparisons, and/or product reviews which the user spent time reviewing.

Targeting program 112 performs text analytics, including, for example, natural language processing (NLP), on any retrieved text or list to determine one or more products, items, or services the user may be interested in browsing for or purchasing. In various embodiments, targeting program 112 uses both a query analysis and a history of products or services purchased. Targeting program 112 may store identified items, products, or services in a database on server computing device 110 (not shown). In an example, a customer performs a web browser search for patio furniture and visits various websites to view patio furniture, however the customer decides to wait before purchasing. Targeting program 112 retrieves the user's search history and stores the information that the user is interested in patio furniture.

Targeting program 112 determines a location of the user (204). In an embodiment, targeting program 112 determines the location of the user based on a location of the user's mobile computing device, such as mobile computing device 130. The location may be determined using known location determining methods, for example, using GPS capabilities of the mobile computing device. In various other embodiments, the location of the user may be determined utilizing other location tracking services or devices associated with the user and/or the user's mobile computing device.

Targeting program 112 determines at least one merchant within a distance of the user (206). In an embodiment of the present invention, the user stores proximity preferences with targeting program 112 indicating a preferred distance to travel, or a preferred location, zone, city, or neighborhood for shopping. Targeting program 112 retrieves the proximity preferences for use in determining at least one merchant. In another embodiment, targeting program 112 includes a default proximity, such as ten miles. Targeting program 112 determines at least one merchant within a distance or proximity of the user, based on the determined user location. In various embodiments, targeting program 112 may only determine a merchant if the merchant has previously registered with targeting program 112 or if the user has stored a preference for the merchant. In various embodiments, targeting program 112 determines a merchant within a threshold distance of a preferred distance, for example, within ten miles of a preferred city or neighborhood.

Targeting program 112 determines whether the at least one merchant has the product or service available (208). In an embodiment of the present invention, targeting program 112 retrieves information from an online website of the at least one merchant in order to determine whether the at least one merchant provides the product or service in which the user is interested, and whether the product or service is available. Targeting program 112 can perform known text analytic processes on the retrieved information to determine product details, e.g., price, description, color, size, and whether the product or service is available at a physical location of the at least one merchant. Targeting program 112 may determine whether the online website contains text such as, for example, “available only online”, indicating the product or service is not available at the physical location. In another embodiment of the present invention, the at least one merchant provides targeting program 112 with information regarding available products and services. In still another embodiment, targeting program 112 retrieves available product information from one or more additional sources available online, for example, a blog post providing a recommendation for a product and including information on where it may be purchased.

If the at least one merchant does not have the product or service available (decision 208, “no” branch), targeting program 112 returns to determine at least one merchant within a distance of the user (206). In various embodiments, a user sets a preference including a first preferred distance and one or more additional preferred distances. If there are no merchants within the first preferred distance with the product or service available, targeting program 112 determines whether there is at least one merchant within the one or more additional preferred distances. In embodiments, the one or more additional preferred distances are greater than the first distance. In an embodiment, the user determines a maximum distance and targeting program 112 does not search for a merchant beyond the maximum distance. In an embodiment, if the at least one merchant does not have the product or service available, targeting program 112 determines one or more similar products to the product or service the user is interested in that are available with the at least one merchant, and provides information to the user on the one or more similar products.

Responsive to determining the at least one merchant has the product or service available (decision 208, “yes” branch), targeting program 112 generates an alert to the user indicating availability of the product or service (210). In an embodiment, when targeting program 112 determines a match between the product or service and availability at the at least one merchant, an alert is generated and provided to the user indicating the product or service is available at the at least one merchant. The alert may contain product details and price information. In embodiments, the alert is provided to the user on a display of the mobile computing device, for example, a user interface of mobile computing device 130. In various embodiments, the alert is provided to the user via an email, an SMS message, a push notification, or any other known manner of sending a message to the user, either on the mobile computing device of the user, or another computing device associated with the user. In another embodiment, targeting program 112 generates a reminder to the user that the user added the product or service to a wish list or other list, and the product or service is available near the user location.

In embodiments where more than one merchant is identified as having the product or service available, a list of the more than one merchant is provided to the user. The list may contain, for example, price information at each merchant, a distance to each merchant, or other items available at each merchant. In an embodiment, the list may rank the more than one merchant, based on, for example, a merchant reputation, a number of the product available, price information, and/or whether any incentives may be offered by a merchant. A merchant reputation may be determined based on known consumer report information or customer reviews.

In the example referred to above, targeting program 112 determines, based on the user location and the user's interest in patio furniture, a store near the customer selling patio furniture, and provides the information to the customer. In another example, the customer may not know that the store sells patio furniture, and visits the store for clothing. Targeting program 112 can provide an alert to the user reminding the customer of her search for patio furniture, and indicating that the store currently has a sale on patio furniture.

In an embodiment of the present invention, targeting program 112 determines one or more incentives associated with either the product or service, with the at least one merchant, or with a rewards program the user belongs to, including a rewards program offered by the at least one merchant. Targeting program 112 can provide the one or more incentives tailored to the user, for example, coupon or deal information, in addition to indicating the availability of the product or service at the at least one merchant. The inventive information may include, for example, merchant deals or coupons specific to the product or service of interest to the user. Targeting program 112 may determine the one or more incentives by retrieving the coupon or deal information from a website of the at least one merchant, or an online newspaper or other advertisement source.

FIG. 3 depicts a block diagram 300 of components of server computing device 110 within data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server computing device 110 can include processor(s) 302, memory 304, cache 306, persistent storage 310, communications unit 314, input/output (I/O) interface(s) 312 and communications fabric 308. Communications fabric 308 provides communications between memory 304, cache 306, persistent storage 310, communications unit 314, and input/output (I/O) interface(s) 312. Communications fabric 308 can be implemented with any architecture designed for passing data and/or control information between processors (such as microprocessors, communications and network processors, etc.), system memory, peripheral devices, and any other hardware components within a system. For example, communications fabric 308 can be implemented with one or more buses.

Memory 304 and persistent storage 310 are computer readable storage media. In this embodiment, memory 304 includes random access memory (RAM). In general, memory 304 can include any suitable volatile or non-volatile computer readable storage media. Cache 306 is a fast memory that enhances the performance of processor(s) 302 by holding recently accessed data, and data near recently accessed data, from memory 304.

Program instructions and data used to practice embodiments of the present invention can be stored in persistent storage 310 for execution and/or access by one or more of the respective processor(s) 302 of server computing device 110 via cache 306. In this embodiment, persistent storage 310 includes a magnetic hard disk drive. Alternatively, or in addition to a magnetic hard disk drive, persistent storage 310 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 310 may also be removable. For example, a removable hard drive may be used for persistent storage 310. Other examples include optical and magnetic disks, thumb drives, and smart cards that are inserted into a drive for transfer onto another computer readable storage medium that is also part of persistent storage 310.

Communications unit 314, in these examples, provides for communications with other data processing systems or devices, including resources of mobile computing device 130. In these examples, communications unit 314 includes one or more network interface cards. Communications unit 314 may provide communications through the use of either or both physical and wireless communications links. Software and data used to practice embodiments of the present invention may be downloaded to persistent storage 310 through communications unit 314.

I/O interface(s) 312 allows for input and output of data with other devices that may be connected to server computing device 110. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention can be stored on such portable computer readable storage media and can be loaded onto persistent storage 310 via I/O interface(s) 312. I/O interface(s) 312 also connect to a display 318.

Display 318 provides a mechanism to display data to a user and may be, for example, a computer monitor or an incorporated display screen, such as is used, for example, in tablet computers and smart phones.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

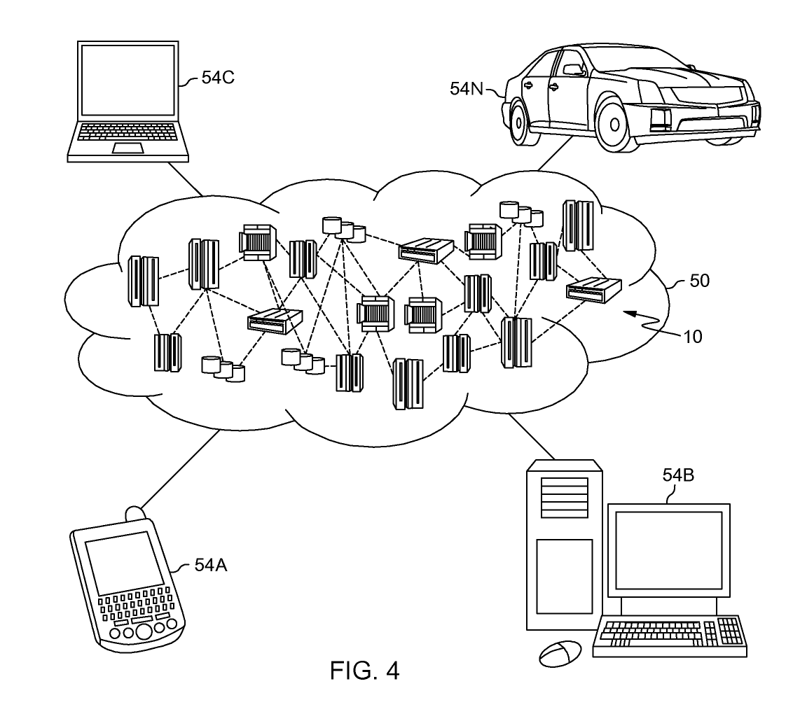

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that cloud computing nodes 10 and cloud computing environment 50 can communicate with any type of computerized device over any type of network and/or network addressable connection (e.g., using a web browser).

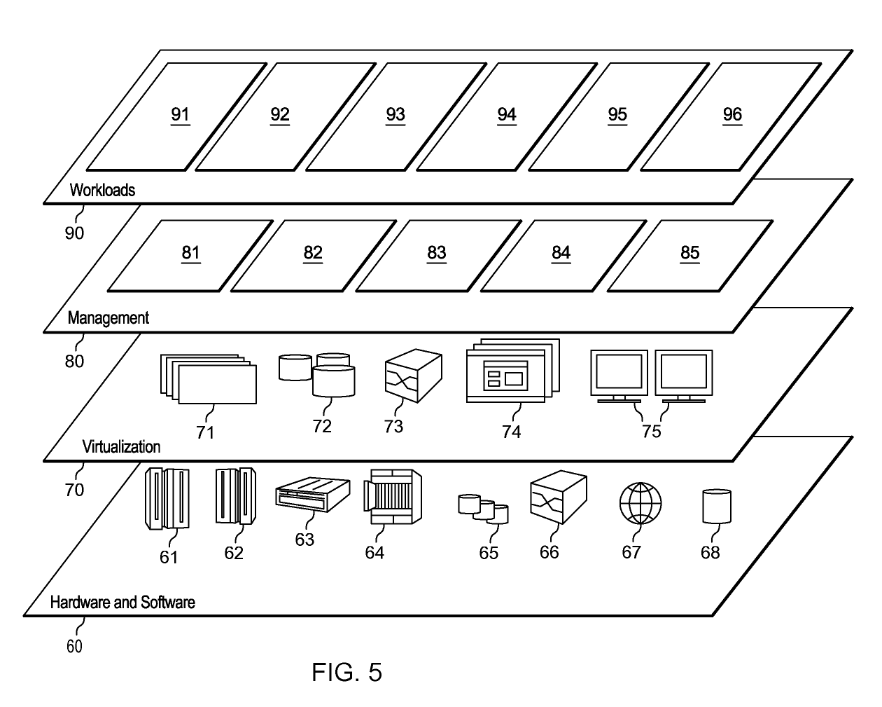

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and targeting program 96.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for determining targeted marketing for a user, the method comprising:
determining, by one or more computer processors, a user interest in at least one product;
determining, by one or more computer processors, a location of the user;
determining, by one or more computer processors, at least one merchant within a first distance of the user;
determining, by one or more computer processors, whether the at least one merchant has the at least one product available; and
responsive to determining the at least one merchant has the at least one product, generating, by one or more computer processors, an alert to the user indicating availability of the at least one product.

2. The method of claim 1, wherein determining the user interest in the at least one product further comprises:
retrieving, by one or more computer processors, text from at least one of a user search history and a user created list; and
performing, by one or more computer processors, text analytics on the retrieved text to determine the at least one product.

3. The method of claim 1, further comprising:
determining, by one or more computer processors, an incentive associated with the at least one product; and
providing, by one or more computer processors, the incentive in addition to the alert to the user.

4. The method of claim 1, further comprising:
responsive to determining the at least one merchant does not have the at least one product available, determining, by one or more computer processors, at least one merchant within one or more additional distances of the user, wherein the one or more additional distances are greater than the first distance.

5. The method of claim 1, wherein determining at least one merchant within a first distance of the user further comprises:
retrieving, by one or more computer processors, a preferred location for the user; and
determining, by one or more computer processors, at least one merchant within the preferred location.

6. The method of claim 1, wherein determining whether the at least one merchant has the at least one product available further comprises:
retrieving, by one or more computer processors, product availability information from a website of the at least one merchant.

7. The method of claim 1, wherein generating the alert to the user further comprises providing, by one or more computer processors, price information for the at least one product at each of the at least one merchant.

8. A computer program product for determining targeted marketing for a user, the computer program product comprising:
one or more computer readable storage devices and program instructions stored on the one or more computer readable storage devices, the stored program instructions comprising:
program instructions to determine a user interest in at least one product;
program instructions to determine a location of the user;
program instructions to determine at least one merchant within a first distance of the user;
program instructions to determine whether the at least one merchant has the at least one product available; and
responsive to determining the at least one merchant has the at least one product, program instructions to generate an alert to the user indicating availability of the at least one product.

9. The computer program product of claim 8, wherein the stored program instructions to determine the user interest in the at least one product further comprise:
program instructions to retrieve text from at least one of a user search history and a user created list; and
program instructions to perform text analytics on the retrieved text to determine the at least one product.

10. The computer program product of claim 8, further comprising:
program instructions to determine an incentive associated with the at least one product; and
program instructions to provide the incentive in addition to the alert to the user.

11. The computer program product of claim 8, further comprising:
responsive to determining the at least one merchant does not have the at least one product available, program instructions to determine at least one merchant within one or more additional distances of the user, wherein the one or more additional distances are greater than the first distance.

12. The computer program product of claim 8, wherein the stored program instructions to determine at least one merchant within a first distance of the user further comprise:
program instructions to retrieve a preferred location for the user; and
program instructions to determine at least one merchant within the preferred location.

13. The computer program product of claim 8, wherein the stored program instructions to determine whether the at least one merchant has the at least one product available further comprise:
program instructions to retrieve product availability information from a website of the at least one merchant.

14. The computer program product of claim 8, wherein the stored program instructions to generate the alert to the user further comprise program instructions to provide price information for the at least one product at each of the at least one merchant.

15. A computer system for determining targeted marketing for a user, the computer system comprising:
one or more computer processors;
one or more computer readable storage devices;
program instructions stored on the one or more computer readable storage devices for execution by at least one of the one or more computer processors, the stored program instructions comprising:
program instructions to determine a user interest in at least one product;
program instructions to determine a location of the user;
program instructions to determine at least one merchant within a first distance of the user;
program instructions to determine whether the at least one merchant has the at least one product available; and
responsive to determining the at least one merchant has the at least one product, program instructions to generate an alert to the user indicating availability of the at least one product.

16. The computer system of claim 15, wherein the stored program instructions to determine the user interest in the at least one product further comprise:
program instructions to retrieve text from at least one of a user search history and a user created list; and
program instructions to perform text analytics on the retrieved text to determine the at least one product.

17. The computer system of claim 15, further comprising:
program instructions to determine an incentive associated with the at least one product; and
program instructions to provide the incentive in addition to the alert to the user.

18. The computer system of claim 15, further comprising:
responsive to determining the at least one merchant does not have the at least one product available, program instructions to determine at least one merchant within one or more additional distances of the user, wherein the one or more additional distances are greater than the first distance.

19. The computer system of claim 15, wherein the stored program instructions to determine at least one merchant within a first distance of the user further comprise:
program instructions to retrieve a preferred location for the user; and
program instructions to determine at least one merchant within the preferred location.

20. The computer system of claim 15, wherein the stored program instructions to determine whether the at least one merchant has the at least one product available further comprise:
program instructions to retrieve product availability information from a website of the at least one merchant.
